(19) United States
(12) Patent Application Publication
(10) Pub. No.: US 2020/0054032 A1
(43) Pub. Date: Feb. 20, 2020

(54) MULTI-CHAMBER SMOKE TRAY FOR AN INDOOR SMOKER

(71) Applicant: Haier US Appliance Solutions, Inc., Wilmington, DE (US)

(72) Inventors: Tomas Garces, Louisville, KY (US); Daniel Carballo, Louisville, KY (US)

(21) Appl. No.: 16/102,886

(22) Filed: Aug. 14, 2018

(51) Int. Cl. A23B 4/052; A47J 37/07

(52) U.S. Cl. CPC A23B 4/0523; A23V 2002/00; A47J 37/0704

(57) ABSTRACT

An indoor smoker includes a firebox defining a smoldering chamber and a smoke tray positioned within the smoldering chamber and having a plurality of chambers, each having a dedicated smoldering heater. The plurality of chambers may be thermally isolated to prevent cross-ignition of combustible material between chambers. In addition, the smoldering heaters may be selectively energized to selectively smolder the combustible material in each of the plurality of chambers.

### FIELD OF THE INVENTION

The present subject matter relates generally to indoor smokers, and more particularly to systems and methods of smoke regulation in indoor smokers.

### BACKGROUND OF THE INVENTION

Conventional smokers include a smoking chamber and a firebox positioned within or fluidly coupled to the smoking chamber. The firebox is filled with a combustible material, such as wood or wood byproducts that are ignited or otherwise heated to generate smoke and/or heat. The heat and smoke are routed into the smoking chamber to impart flavor on and cook food items positioned within the smoking chamber. One or more heating elements may be positioned within the smoking chamber and the firebox to maintain the temperatures necessary both for cooking the food and for generating the desired amount of smoke.

However, conventional smokers use a single firebox containing a single volume of combustible material. Therefore, fireboxes typically are loaded with a single type of wood or a single mixture of wood chips or pellets. In addition, such fireboxes typically include a single heating element or igniter to raise the temperature of the combustible material to the smoldering temperature. Once ignited, the combustible material continues to burn until all the combustible material is consumed or the smoking process is stopped. Therefore, conventional fireboxes provide little flexibility in terms of varying smoking times, wood types and materials, and in the ability to generate differing smoke flavor profiles.

Accordingly, a smoker that has features for improved smoke regulation during a smoking operation would be useful. More specifically, an indoor smoker that has features allowing a user to use different combustible materials and burn schedules during a single smoking process would be particularly beneficial.

### BRIEF DESCRIPTION OF THE INVENTION

Aspects and advantages of the invention will be set forth in part in the following description, may be apparent from the description, or may be learned through practice of the invention.

In one aspect of the present disclosure, an indoor smoker defining a vertical, a lateral, and a transverse direction is provided. The indoor smoker includes a firebox defining a firebox inlet, a firebox outlet, and a smoldering chamber. An air handler is operably coupled with firebox for urging a flow of air through the smoldering chamber and a smoke tray is positioned within the smoldering chamber and includes a plurality of chambers, each of the plurality of chambers being configured for receiving combustible material. A plurality of smoldering heaters is positioned within the smoldering chamber, each of the plurality of smoldering heaters being configured for smoldering the combustible material in one of the plurality chambers.

In another aspect of the present disclosure, a method of operating an indoor smoker is provided. The indoor smoker includes a firebox defining a firebox inlet, a firebox outlet, and a smoldering chamber, an air handler operably coupled with firebox, and a smoke tray positioned within the smoldering chamber and including a first chamber and a second chamber for receiving combustible material. The method includes receiving a command to initiate a smoking process, operating the air handler to urge a flow of air into the smoldering chamber, igniting the combustible material in the first chamber using a first heating element at a first ignition time, and igniting the combustible material in the second chamber using a second heating element at a second ignition time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an indoor smoker with all doors in a closed position in accordance with an example embodiment of the present disclosure.

FIG. 2 provides a perspective view the exemplary indoor smoker of FIG. 1 with the doors opened.

FIG. 3 provides a schematic, cross-sectional view of the exemplary indoor smoker of FIG. 1 taken along Line 3-3 of FIG. 1.

FIG. 4 provides a perspective view of a smoke tray that may be used with the exemplary indoor smoker of FIG. 1 according to an exemplary embodiment of the present subject matter.

FIG. 5 provides a front view of the exemplary smoke tray of FIG. 4 according to an exemplary embodiment of the present subject matter.

FIG. 6 provides a top view of the exemplary smoke tray of FIG. 4 according to an exemplary embodiment of the present subject matter.

FIG. 7 is a method of operating an indoor smoker according to an example embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “upstream” and “downstream” refer to the relative direction with respect to fluid flow in a fluid pathway. For example, “upstream” refers to the direction from which the fluid flows, and “downstream” refers to the direction to which the fluid flows. In addition, as used herein, terms of approximation, such as “approximately,” “substantially,” or “about,” refer to being within a ten percent margin of error. Furthermore, the term “smoke” is generally used to refer to the flow of air, smoke, combustion byproducts, or any combination thereof through an appliance.

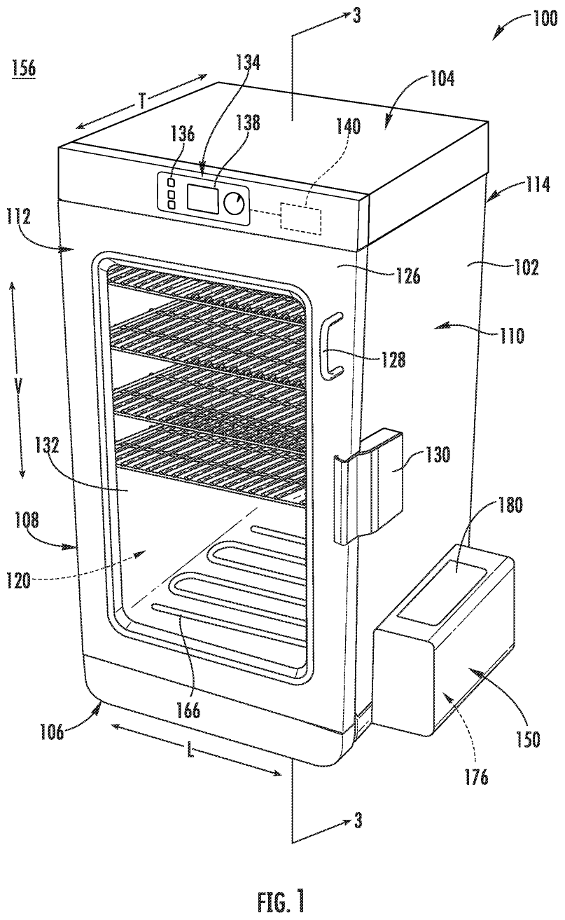

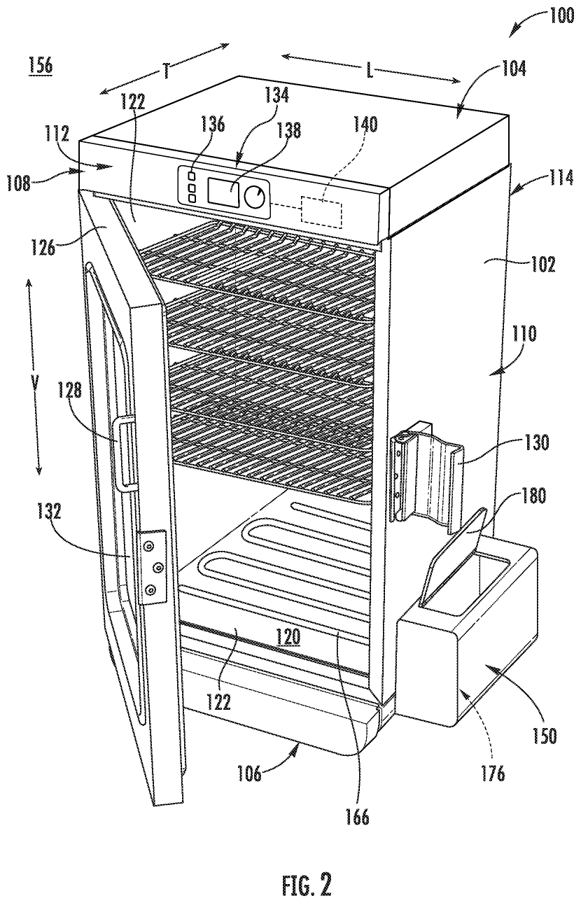

FIGS. 1 and 2 provide perspective views of an indoor smoker 100 according to an exemplary embodiment of the present subject matter with doors in the closed position and the open position, respectively. Indoor smoker 100 generally defines a vertical direction V, a lateral direction L, and a transverse direction T, each of which is mutually perpendicular, such that an orthogonal coordinate system is generally defined. As illustrated, indoor smoker 100 includes an insulated cabinet 102. Cabinet 102 of indoor smoker 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

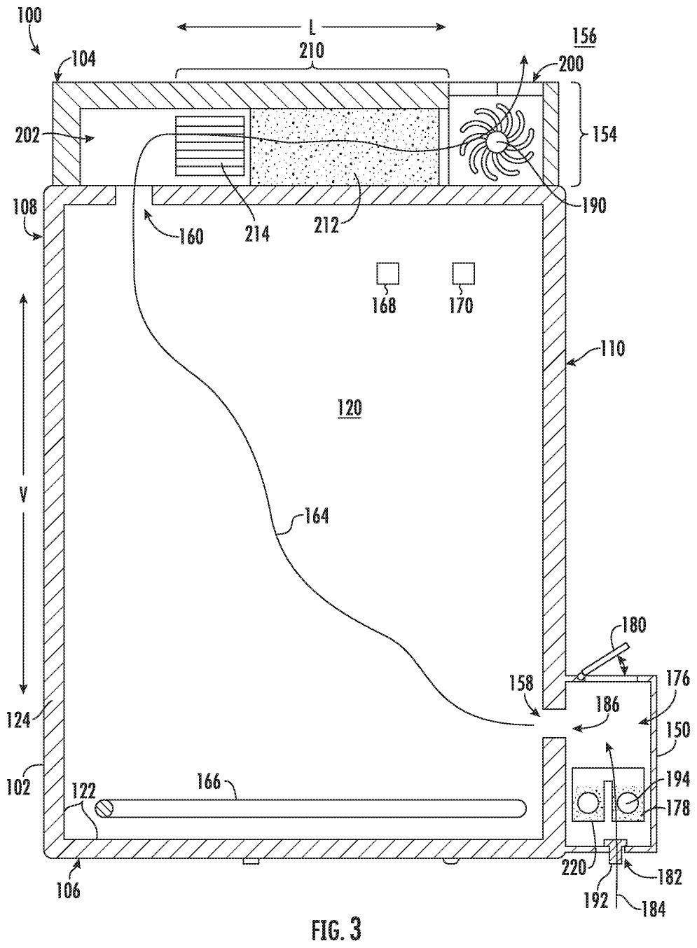

Within cabinet 102 is a smoking chamber 120 which is configured for the receipt of one or more food items to be cooked and/or smoked. In general, smoking chamber 120 is at least partially defined by a plurality of chamber walls 122. Specifically, smoking chamber 120 may be defined by a top wall, a rear wall, a bottom wall, and two sidewalls. These chamber walls 122 may define smoking chamber 120 and an opening through which a user may access food articles placed therein. In addition, chamber walls 122 may be joined, sealed, and insulated to help retain smoke and heat within smoking chamber 120. In this regard, for example, in order to insulate smoking chamber 120, indoor smoker 100 includes an insulating gap defined between chamber walls 122 and cabinet 102. According to an exemplary embodiment, the insulation gap is filled with insulating material 124 (see FIG. 3), such as insulating foam or fiberglass.

Indoor smoker 100 includes a door 126 rotatably attached to cabinet 102 in order to permit selective access to smoking chamber 120. A handle 128 is mounted to door 126 to assist a user with opening and closing door 126 and a latch 130 is mounted to cabinet 102 for locking door 126 in the closed position during a cooking or smoking operation. In addition, door 126 may include one or more transparent viewing windows 132 to provide for viewing the contents of smoking chamber 120 when door 126 is closed and also to assist with insulating smoking chamber 120.

Referring still to FIGS. 1 and 2, a user interface panel 134 and a user input device 136 may be positioned on an exterior of cabinet 102. User interface panel 134 may represent a general purpose Input/Output (“GPIO”) device or functional block. In some embodiments, user interface panel 134 may include or be in operative communication with user input device 136, such as one or more of a variety of digital, analog, electrical, mechanical or electro-mechanical input devices including rotary dials, control knobs, push buttons, and touch pads. User input device 136 is generally positioned proximate to user interface panel 134, and in some embodiments, user input device 136 may be positioned on user interface panel 134. User interface panel 134 may include a display component 138, such as a digital or analog display device designed to provide operational feedback to a user.

Generally, indoor smoker 100 may include a controller 140 in operative communication with user input device 136. User interface panel 134 of indoor smoker 100 may be in communication with controller 140 via, for example, one or more signal lines or shared communication busses, and signals generated in controller 140 operate indoor smoker 100 in response to user input via user input devices 136. Input/Output (“I/O”) signals may be routed between controller 140 and various operational components of indoor smoker 100 such that operation of indoor smoker 100 can be regulated by controller 140.

Controller 140 is a “processing device” or “controller” and may be embodied as described herein. Controller 140 may include a memory and one or more microprocessors, microcontrollers, application-specific integrated circuits (ASICS), CPUs or the like, such as general or special purpose microprocessors operable to execute programming instructions or micro-control code associated with operation of indoor smoker 100, and controller 140 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 140 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of an indoor smoker having a single smoking chamber, it should be appreciated that indoor smoker 100 is provided by way of example only. Other smoking appliances having different configurations, different appearances, and/or different features may also be utilized with the present subject matter, e.g., outdoor smokers, conventional oven appliances, or other suitable cooking appliances. Thus, the example embodiment shown in FIG. 1 is not intended to limit the present subject matter to any particular smoking configuration or arrangement. Moreover, aspects of the present subject matter may be used in any other consumer or commercial appliance where it is desirable to regulate a flow of smoke or heated air in an appliance.

Referring now also to FIG. 3, various internal components of indoor smoker 100 and their respective functions will be described according to an exemplary embodiment of the present subject matter. In this regard, FIG. 3 illustrates a schematic cross-sectional view of indoor smoker 100 taken along Line 3-3 of FIG. 1. As shown, indoor smoker 100 generally includes smoking chamber 120 for receiving items to be cooked/smoked, a firebox 150 for generating smoke, and an exhaust system 154 for safely discharging that smoke into an indoor environment 156 (i.e., outside of indoor smoker 100). Each of these will be described in detail below.

As illustrated, smoking chamber 120 defines a chamber inlet 158 and a chamber outlet 160. During a smoking operation, a flow of smoke (identified in FIG. 3 by reference numeral 164) is drawn into smoking chamber 120 through chamber inlet 158 is discharged from smoking chamber 120 through chamber outlet 160 and exhaust system 154. According to an exemplary embodiment, chamber inlet 158 is defined proximate a bottom 106 of smoking chamber 120 at one side (e.g., second side 110 as shown) and the chamber outlet 160 is defined proximate top 104 of smoking chamber 120 at an opposite side (e.g., first side 108 as shown). In this manner, the flow of smoke 164 may have a tendency of being drawn over and up through the entire smoking chamber 120 for improved smoke coverage. However, it should be appreciated that according to alternative embodiment, chamber inlet 158 and chamber outlet 160 may be positioned at any other suitable location that is in fluid communication with smoking chamber 120.

In order to ensure a desirable cooking temperature within smoking chamber 120, indoor smoker 100 further includes a chamber heater 166 that is positioned within or otherwise in thermal communication with smoking chamber 120 for regulating the temperature in smoking chamber 120. In general, chamber heater 166 may include one or more heating elements positioned within cabinet 102 for selectively heating smoking chamber 120. For example, the heating elements may be electric resistance heating elements, gas burners, microwave heating elements, halogen heating elements, or suitable combinations thereof. Notably, because chamber heater 166 is operated independently of firebox 150 (e.g., as described below), smoking chamber 120 may be maintained at any suitable temperature during a smoking process. More specifically, for example, chamber heater 166 may be turned off or on a very low setting for smoking cheeses or may be turned on high for quickly cooking and smoking meats.

In some embodiments, indoor smoker 100 also includes one or more sensors that may be used to facilitate improved operation of the appliance, such as described below. For example, indoor smoker 100 may include one or more temperature sensors and/or humidity sensors which are generally operable to measure the internal temperature and humidity in indoor smoker 100, e.g., within smoking chamber 120. More specifically, as illustrated, indoor smoker 100 includes a temperature sensor 168 and a humidity sensor 170 positioned within smoking chamber 120 and being operably coupled to controller 140. In some embodiments, controller 140 is configured to vary operation of chamber heater 166 based on one or more temperatures detected by temperature sensor 168 or humidity measurements from humidity sensor 170.

As described herein, “temperature sensor” may refer to any suitable type of temperature sensor. For example, the temperature sensors may be thermocouples, thermistors, or resistance temperature detectors. Similarly, “humidity sensor” may refer to any suitable type of humidity sensor, such as capacitive digital sensors, resistive sensors, and thermal conductivity humidity sensors. In addition, temperature sensor 168 and humidity sensor 170 may be mounted at any suitable location and in any suitable manner for obtaining a desired temperature or humidity measurement, either directly or indirectly. Although exemplary positioning of certain sensors is described below, it should be appreciated that indoor smoker 100 may include any other suitable number, type, and position of temperature and/or humidity sensors according to alternative embodiments.

Referring still to FIG. 3, firebox 150 generally defines a smoldering chamber 176 which is configured for receiving combustible material 178, as described in more detail below. According to the exemplary embodiment, firebox 150 may include a door 180 which is pivotally mounted on top of firebox 150 for providing selective access to smoldering chamber 176, e.g., to add additional combustible material 178. As used herein, “combustible material” is generally used to refer to any suitable material positioned within smoldering chamber 176 for generating smoke. Specifically, according to exemplary embodiments, combustible material 178 includes wood or wood byproducts, such as wood chunks, wood chips, wood pellets, or wood resin.

As best illustrated in FIG. 3, firebox 150 defines an air inlet or a firebox inlet 182 for receiving air to support the combustion or smoldering process. Specifically, firebox inlet 182 is configured for receiving a flow of air (indicated by reference numeral 184 in FIG. 3) from the ambient environment surrounding indoor smoker 100 or from another air supply source. Firebox 150 further defines a firebox outlet 186 that is fluidly coupled to chamber inlet 158 for providing the flow of smoke 164 into smoking chamber 120 during a smoking operation.

As will be described in more detail below, indoor smoker 100 includes an air handler 190 for urging the flow of air 184 into smoldering chamber 176 through firebox inlet 182 for facilitating the smoldering process and smoke generation. In addition, indoor smoker 100 may further include features for preventing or regulating the flow of air 184 from entering indoor smoker 100 from environment 156 when the flow of such air is not desired. In this regard, for example, indoor smoker 100 may include a firebox check valve 192 which is operably coupled to firebox inlet 182. In general, this check valve prevents the flow of air 184 from entering smoldering chamber 176 when not desired.

For example, firebox check valve 192 may have a “cracking pressure,” which is used herein to refer to the pressure, or more precisely the negative pressure, required within smoldering chamber 176 to open firebox check valve 192. In this manner, firebox check valve 192 may be designed to permit the flow of air 184 only when air handler 190 is operating, thus facilitating the quick and effective asphyxiation of combustible material 178 within smoldering chamber 176 when desired.

Referring still to FIG. 3, firebox 150 includes one or more smoldering heaters 194 (described in detail below) which are positioned in smoldering chamber 176 or otherwise placed in thermal communication with combustible material 178 stored in smoldering chamber 176 for smoldering combustible material 178. Similar to chamber heater 166, smoldering heater 194 may include one or more heating elements such as electric resistance heating elements, gas burners, microwave heating elements, halogen heating elements, or suitable combinations thereof. According to an exemplary embodiment, smoldering heaters 194 are cartridge heaters or a silicon nitride igniters. In addition, firebox 150 may include a dedicated temperature sensor 168 and humidity sensor 170 (not shown in smoldering chamber 176) for detecting the temperature and humidity within smoldering chamber 176 for improved smoke generation and regulation.

As used herein, the verb “smolder” or variations thereof is intended to refer to burning a combustible material (e.g., combustible material 178) slowly such that smoke is generated but little or no flame is generated. In this manner, the combustible material is not expended quickly, but a large amount of smoke is generated for the smoking process. Notably, the burn rate of combustible material and the amount of smoke generated is regulated using smoldering heater 194 positioned within smoldering chamber 176. For typical combustible material used in smokers, e.g., wood and wood byproducts, a typical smoldering temperature is between about 650° F. and 750° F. However, the exact temperature may vary depending on the combustible material used, the air flow rate through smoldering chamber 176, the level of combustible material 178, and other factors.

As mentioned briefly above, indoor smoker 100 further includes an exhaust system 154 which is generally configured for safely discharging the flow of smoke 164 from indoor smoker 100. Specifically, according to the illustrated embodiment, exhaust system 154 generally extends between chamber outlet 160 and a discharge vent 200 defined by cabinet 102 for directing the flow of smoke 164 from smoking chamber 120 to the environment 156. Although an exemplary exhaust system 154 is described below, it should be appreciated that variations and modifications may be made while remaining within the scope of the present subject matter. For example, the routing of ducts, the position of fans and dampers, and the types of sensors used may vary according to alternative embodiments.

As shown, exhaust system 154 includes an exhaust duct 202 that generally extends between and provides fluid communication between chamber outlet 160 and discharge vent 200. Air handler 190 is operably coupled with exhaust duct 202 for urging the flow of smoke 164 through exhaust duct 202 and out of discharge vent 200 to environment 156. According to the illustrated exemplary embodiment, air handler 190 is a tangential fan positioned within exhaust duct 202. However, it should be appreciated that according to alternative embodiments, air handler 190 may be positioned at any other suitable location and may be any other suitable fan type, such as an axial fan, a centrifugal fan, etc. In addition, according to an exemplary embodiment, air handler 190 is a variable speed fan such that it may rotate at different rotational speeds, thereby generating different air flow rates. In this manner, the amount of smoke drawn from smoldering chamber 176 may be continuously and precisely regulated.

As illustrated, indoor smoker 100 further includes a catalytic converter 210 which is positioned within exhaust duct 202 for lowering or removing volatile organic compounds (VOCs) from the flow of smoke 164. As used herein, “catalytic converter” or variations thereof may be used to refer to any component, machine, or device that is configured for removing or lowering volatile organic compounds (VOCs), toxic gases, harmful emissions, pollutants, or undesirable compounds from a flow of air and smoke. For example, according to the illustrated embodiment, catalytic converter 210 generally includes a catalytic element 212 and a catalyst heater 214. In general, catalytic element 212 includes a material that causes an oxidation and a reduction reaction. For example, precious metals such as platinum, palladium, and rhodium are commonly used as catalyst materials, though other catalysts are possible and within the scope of the present subject matter. In operation, the catalytic element 212 may combine oxygen (O₂) with carbon monoxide (CO) and unburned hydrocarbons to produce carbon dioxide (CO₂) and water (H₂O). In addition, according to exemplary embodiments, catalytic element 212 may remove nitric oxide (NO) and nitrogen dioxide (NO₂).

Notably, catalytic converters typically require that the catalyst be heated to a suitably high temperature in order to catalyze the necessary chemical reactions. Therefore, catalyst heater 214 is in thermal communication with catalytic element 212 for heating it to a suitable temperature, such as approximately 800° F. According to the illustrated embodiment, catalyst heater 214 is positioned upstream of catalytic element 212 to provide thermal energy through convection. However, it should be appreciated that according to alternative embodiments, catalyst heater 214 may be in direct contact with catalytic element 212 to provide thermal energy through conduction, or may be thermally coupled to catalytic element 212 in any other suitable manner.

Thus, during operation of indoor smoker 100, air handler 190 draws the flow of air 184 into smoldering chamber 176 through firebox inlet 182. The flow of air 184 and combustible material 178 in the smoldering chamber 176 generate the flow of smoke 164 which is drawn into smoking chamber 120 through chamber inlet 158. The flow of smoke 164 passes through smoking chamber 120 for performing a smoking process on food items positioned therein before exiting smoking chamber 120 through chamber outlet 160. Air handler 190 and continues to urge the flow of smoke 164 through catalytic converter 210 and exhaust duct 202 before passing out discharge vent 200.

Referring now to FIGS. 3 through 6, indoor smoker 100 may further include a multi-chamber smoke tray 220 that is positioned within smoldering chamber 176 for receiving combustible material 178. More specifically, according to an exemplary embodiment, smoke tray 220 may be removably positioned within firebox 150 and may include a plurality of sub-trays, compartments, or chambers (identified generally by reference numeral 222) for receiving separate volumes of combustible material 178.

More specifically, according to the illustrated embodiment, chamber 222 of smoke tray 220 includes a first chamber 224 and the second chamber 226 that are positioned adjacent to each other and extend substantially parallel along an entire depth of firebox 150 (e.g., measured along the transverse direction T). In addition, chambers 224, 226 may have a rectangular cross-sectional areas, e.g., when sectioned along the transverse direction T. However, it should be appreciated that according to alternative embodiments, smoke tray 220 may include any suitable number of chambers 222 having any suitable size, geometry, orientation, etc.

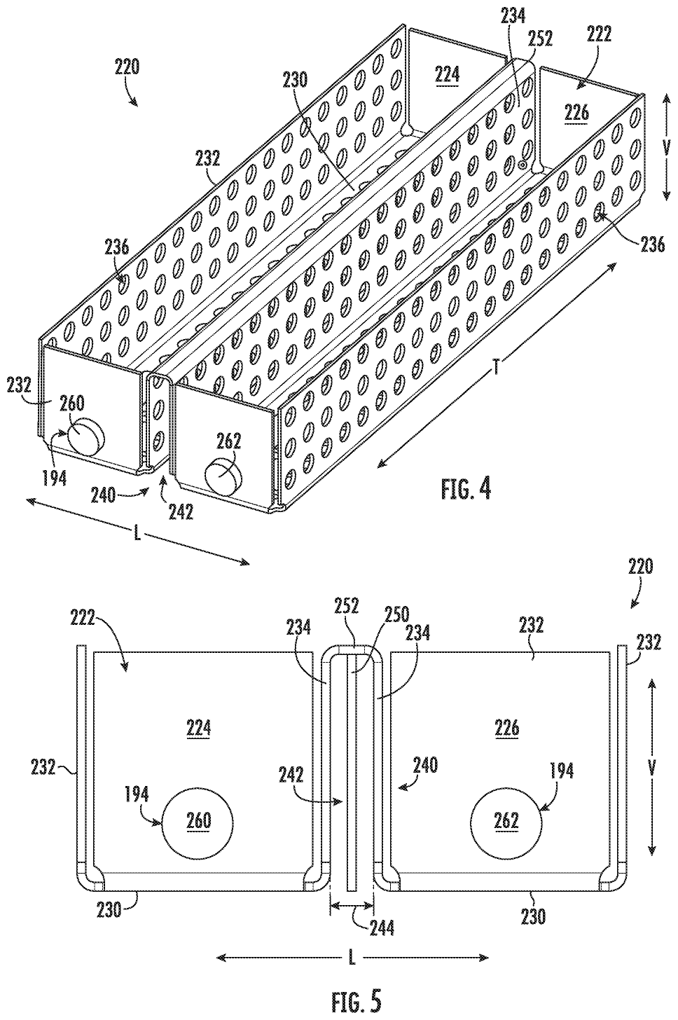

As best shown in FIGS. 4 through 6, smoke tray 220 and is defined by one or more bottom walls 230 that extend substantially along a horizontal direction (e.g., defined by the lateral direction L and the transverse direction T) and a plurality of side walls 232 that extends substantially along the vertical direction V from bottom walls 230. In addition, smoke tray 220 includes one or more divider walls 234 that extend substantially along the vertical direction V and are positioned between sidewalls 232, e.g., to divide smoke tray 220 and define chambers 222.

As illustrated, bottom walls 230, sidewalls 232, and divider walls 234 are integrally formed as a single part. More specifically, smoke tray 220 may be a perforated metal sheet that defines a plurality of perforations 236 and is stamped to form walls 230-234 and chambers 222. However, it should be appreciated that according to alternative embodiments, smoke tray 220 may have any other suitable construction and may be formed from any other suitable material or materials. For example, smoke tray 220 may be formed from a plurality of steel mesh sheets that are positioned, oriented, joined together to form chambers 222. Notably the apertures within mesh sheets or perforations 236 may have any size suitable for permitting the flow of air 184 to pass through smoke tray 220 and combustible material 178, while substantially containing or preventing the combustible material 178 from falling through or out of smoke tray 220.

Notably, each chamber 222 of smoke tray 220 may contain a different combustible material 178. For example, first chamber 224 may contain a first type or quantity of combustible material (e.g., cherry wood chips) while second chamber 226 may contain a second type or quantity of combustible material (e.g., pecan chunks). Indeed, smoke tray 220 may contain any suitable wood (e.g., cherry, pecan, oak, etc.) and type (e.g., wood chunks, wood chips, wood pellets, wood resin, etc.) in each chamber 222 to provide a versatile smoking process with distinct flavor profiles.

Referring still to FIGS. 4 through 6, smoke tray 220 may further include one or more thermal barriers 240 which are positioned between chambers 222 to prevent ignition of combustible material 178 in one chamber (e.g. second chamber 226) by combustible material in another chamber (e.g. first chamber 224). In general, a “thermal barrier” may be any partition, features, or spacing defined by or positioned within smoke tray 220 to provide some level of thermal insulation or separation between adjacent chambers 222.

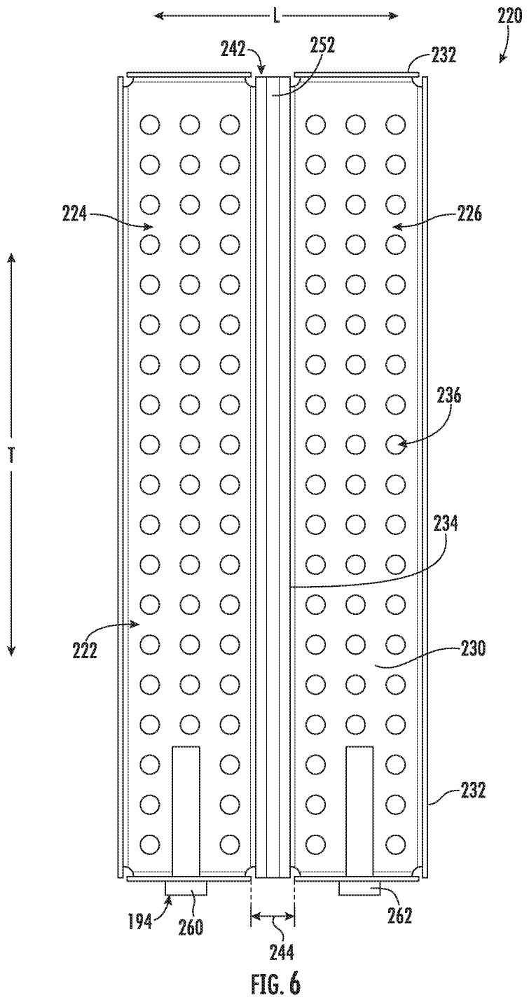

For example, as best illustrated in FIG. 5, smoke tray 220 may include a thermal barrier 240 in the form of an air gap 242 defined between adjacent chambers 222 of smoke tray 220. Specifically, air gap 242 may be defined between two divider walls 234 that define a portion of first chamber 224 and second chamber 226, respectively. Air gap 242 may define a width 244 suitable for preventing thermal energy from the combustible material 178 in first chamber 224 from igniting or smoldering the combustible material 178 and second chamber 226, or vice versa.

Referring still to FIG. 5, thermal barrier 240 may alternatively or additionally include a divider plate 250 that is positioned within air gap 242 and extends substantially along the vertical direction V along the entire depth of smoke tray 220. For example, divider plate 250 may be a piece of solid or perforated steel that is positioned within air gap 242 and may extend down along the vertical direction V from adjoining wall 252 that connects the divider walls 234 of adjacent chambers 224 and 226. Although divider plate 250 is illustrated as a separate floating plate within air gap 242, it should be appreciated that according to alternative embodiments, divider plate 250 may replace divider walls 234 altogether, thereby at least partially defining first chamber 224 and/or second chamber 226. Alternatively, thermal barrier 240 may include only an air gap 242 and no divider plate 250.

Referring again to FIGS. 3 through 6, smoldering heaters 194 of indoor smoker 100 may be operably coupled with each of the chambers 222 of smoke tray 220. In general, a single smoldering heater 194 may be positioned within, mounted on or otherwise thermally coupled with each of first chamber 224 and second chamber 226. More specifically, according to the exemplary embodiment, smoldering heaters 194 include a first heating element 260 thermally coupled to first chamber 224 and a second heating element 262 thermally coupled to second chamber 226. Notably, first heating element 260 and second heating element 262 may be operated independently of each other in order to commence a smoldering process within first chamber 224 and second chamber 226 at different times during a smoking process if desired. Specific methods of regulating smoldering heaters 194 will be described below according to exemplary embodiments of the present subject matter.

Now that the construction and configuration of indoor smoker 100 has been described according to an exemplary embodiment of the present subject matter, an exemplary method 300 for regulating a flow of smoke within or otherwise operating an indoor smoker will be described according to an exemplary embodiment of the present subject matter. Method 300 can be implemented by controller 140 and may be used to operate indoor smoker 100, or any other smoker or cooking appliance. It should be appreciated that the exemplary method 300 is discussed herein only to describe exemplary aspects of the present subject matter, and is not intended to be limiting.

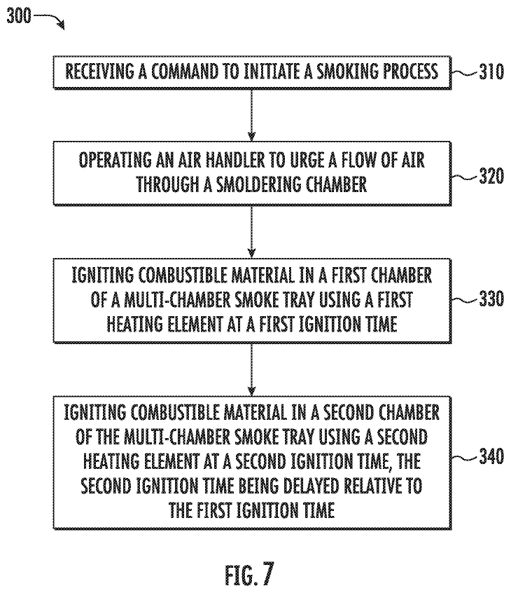

Referring now to FIG. 7, method 300 includes, at step 310, receiving a command to initiate a smoking process. For example, a user of indoor smoker 100 may use user interface panel 134 to input a desired smoking process or schedule. The schedule may include, for example, the duration of the smoking process, different cycles within a smoking process, the ignition time for various chambers 222 during the smoking process, or other parameters associated with the smoking process. Step 320 includes operating the air handler to urge a flow of air into the smoldering chamber, e.g., to facilitate the smoldering process, generate smoke, and circulate that smoke through the smoking chamber.

Step 330 may include igniting the combustible material in a first chamber of a multi-chamber smoke tray using a first heating element at a first ignition time. In addition, step 340 may include igniting combustible material in a second chamber of the multi-chamber smoke tray using a second heating element and a second ignition time. Notably, the first ignition time and the second ignition time may be the same or different. In this regard, according to an exemplary embodiment, there is a time delay between the first ignition time and the second ignition time.

In this regard, continuing the example from above, at step 330, cherry wood chunks positioned within first chamber 224 may be ignited to commence a smoldering process at the start of a smoking process (e.g., at t=0). The cherry chunks may be ignited by first heating element 260 and burn, for example, for approximately four hours. Notably, due to the thermal barrier 240 and multi-chamber configuration of smoke tray 220, the combustible material located in second chamber 226 will not be ignited by the smoking cherry chunks in first chamber 224, unless second heating element 262 is separately energized.

After the combustible material 178 in first chamber 224 has been consumed, it may be desirable to extend the smoking process longer, e.g., with another wood material. Thus, at step 340, pecan chunks positioned within second chamber 226 may be ignited with second heating element 262. The pecan chunks may burn for another time, e.g., four hours to extend the smoke time as well as provide different flavor profiles to the food being smoked.

In addition, although two exemplary wood types and smoking methods are described herein, it should be appreciated that according to alternative embodiments any suitable wood types or materials may be used. In addition, any suitable smoking or ignition schedule may be used to fill the smoking chamber with the desired type of smoke at the desired times during a smoking process. Moreover, other variations and modifications may be in applied while remaining within the scope of the present subject matter.

FIG. 7 depicts an exemplary method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using indoor smoker 100 as an example, it should be appreciated that these methods may be applied to regulate smoke in any other smoking appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An indoor smoker defining a vertical, a lateral, and a transverse direction, the indoor smoker comprising:
a firebox defining a firebox inlet, a firebox outlet, and a smoldering chamber;
an air handler operably coupled with firebox for urging a flow of air through the smoldering chamber;
a smoke tray positioned within the smoldering chamber and comprising a plurality of chambers, each of the plurality of chambers being configured for receiving combustible material; and
a plurality of smoldering heaters positioned within the smoldering chamber, each of the plurality of smoldering heaters being configured for smoldering the combustible material in one of the plurality chambers.

2. The indoor smoker of claim 1, comprising:
a cabinet including an exhaust duct;
a smoking chamber positioned within the cabinet and defining a chamber inlet in fluid communication with the firebox outlet, a chamber outlet in fluid communication with the exhaust duct, wherein the air handler is operably coupled with the exhaust duct for urging a flow of smoke into smoking chamber from the smoldering chamber and out of the smoking chamber through the exhaust duct.

3. The indoor smoker of claim 1, wherein the plurality of chambers comprises a first chamber and a second chamber, and wherein the plurality of smoldering heaters comprises a first heating element thermally coupled to the first chamber and a second heating element thermally coupled to the second chamber, the indoor smoker further comprising:
a controller operably coupled to the air handler and the smoldering heaters, the controller being configured for:
igniting the combustible material in the first chamber using the first heating element at a first ignition time; and
igniting the combustible material in the second chamber using the second heating element at a second ignition time.

4. The indoor smoker of claim 3, wherein there is a time delay between the first ignition time and the second ignition time.

5. The indoor smoker of claim 1, wherein the smoke tray comprises:
one or more thermal barriers positioned between the plurality of chambers to prevent ignition of combustible material in one chamber by combustible material in another chamber.

6. The indoor smoker of claim 5, wherein the one or more thermal barriers comprises:
an air gap defined between adjacent chambers of the plurality of chambers.

7. The indoor smoker of claim 5, wherein the one or more thermal barriers comprises:
a divider plate positioned between adjacent chambers of the plurality of chambers.

8. The indoor smoker of claim 7, wherein the divider plate comprises a steel mesh or perforated metal plate.

9. The indoor smoker of claim 1, wherein the smoldering heaters are cartridge heaters or a silicon nitride igniters.

10. The indoor smoker of claim 1, wherein at least two of the plurality of chambers contain different combustible materials.

11. The indoor smoker of claim 1, wherein the smoke tray is defined by one or more bottom walls that extend substantially along a horizontal direction, a plurality of sidewalls that extend substantially along the vertical direction, and one or more divider walls that extend substantially along the vertical direction.

12. The indoor smoker of claim 11, wherein the bottom walls, the sidewalls, and the divider walls are all integrally formed as a single part.

13. The indoor smoker of claim 1, wherein the plurality of chambers comprises a first chamber and a second chamber which extend parallel to each other along an entire depth of the firebox and which have rectangular cross sections.

14. The indoor smoker of claim 1, comprising:
a chamber heater for heating the smoking chamber.

15. The indoor smoker of claim 2, comprising:
a catalytic converter positioned within the exhaust duct for lowering volatile organic compounds within the flow of smoke.

16. A method of operating an indoor smoker, the indoor smoker comprising a firebox defining a firebox inlet, a firebox outlet, and a smoldering chamber, an air handler operably coupled with firebox, and a smoke tray positioned within the smoldering chamber and comprising a first chamber and a second chamber for receiving combustible material, the method comprising:
receiving a command to initiate a smoking process;
operating the air handler to urge a flow of air into the smoldering chamber;
igniting the combustible material in the first chamber using a first heating element at a first ignition time; and
igniting the combustible material in the second chamber using a second heating element at a second ignition time.

17. The method of claim 16, wherein there is a time delay between the first ignition time and the second ignition time.

18. The method of claim 16, wherein the smoke tray comprises:
a thermal barrier positioned between the first chamber and the second chamber to prevent ignition of combustible material in one chamber by combustible material in another chamber.

19. The method of claim 18, wherein the thermal barrier comprises:
an air gap defined between the first chamber and the second chamber.

20. The method of claim 18, wherein the thermal barrier comprises:
a divider plate positioned between the first chamber and the second chamber.
